(19) United States
(12) Patent Application Publication
(10) Pub. No.: US 2015/0214534 A1
(43) Pub. Date: Jul. 30, 2015

(54) DEVICES AND METHODS FOR CONNECTING BATTERY CELLS

(71) Applicant: Ford Global Technologies, LLC, Dearborn, MI (US)

(72) Inventors: DEBBI CALLICOAT, LIVONIA, MI (US); RAYMOND C. SICIAK, ANN ARBOR, MI (US)

(73) Assignee: Ford Global Technologies, LLC, Dearborn, MI (US)

(21) Appl. No.: 14/165,510

(22) Filed: Jan. 27, 2014

(51) Int. Cl. H01M 2/24; B23K 1/00; H01M 2/20

(52) U.S. Cl. CPC H01M 2/24; H01M 2/206; B23K 1/0016; H01M 2220/20; B23K 2001/12

(57) ABSTRACT

A vehicle traction battery assembly includes a bus bar insulator having a recess configured to receive a bus bar and an opposite side covering the bus bar and defining a welding slot sized to permit a welding beam to weld the bus bar to two adjacent battery cells and to inhibit human contact with the bus bar through the welding slot. A method for assembling a vehicle traction battery having battery cells includes positioning bus bars within corresponding openings of a bus bar insulator that covers one side of each bus bar and has welding slots with a welding slot for each of the battery cells and welding the bus bars to the associated battery cells through the welding slots.

### TECHNICAL FIELD

The present disclosure relates to devices and methods for connecting battery cells, such as the battery cells in traction batteries of hybrid or electric vehicles.

### BACKGROUND

Traction batteries, such as those in hybrid or electric vehicles, consist of interconnected battery cells. The battery cells may be connected by bus bars to reach a desired voltage. The interconnected battery cells form an array. The traction batteries may have multiple arrays connected together by one or more bus bars to further boost capacity and current handling. The bus bars may be attached to associated battery cells using fasteners, which can be labor intensive with associated costs. In addition, fastening the bus bars to the battery cells may result in cross-threading during assembly or maintenance and must then have the fastener replaced and/or the tapped hole repaired.

Individual battery cells of lower voltage are often connected in series to form high voltage arrays. Assembly and maintenance processes have been designed to reduce or eliminate exposure of personnel to high voltage. For example, cell arrays may be divided into sections so that each section has less than 50 volts, or a non-conductive shield or cover may be positioned around the bus bars. While effective for many applications, the shields or covers may not be properly positioned or become detached exposing high voltage components.

### SUMMARY

The present disclosure relates to a vehicle traction battery assembly that includes a bus bar insulator having a first side with a recess configured to receive a bus bar. The bus bar insulator has an opposite side covering the bus bar and defining at least one welding slot. The welding slot is sized to permit a welding beam to weld the bus bar to at least two adjacent battery cells and to prevent human contact with the bus bar through the at least one welding slot. The vehicle fraction battery assembly may have a wiring harness management channel or duct integrally formed with the bus bar insulator. The wiring harness duct includes a plurality of walls that define a channel for receiving a plurality of wires. The duct may include an opening associated with each adjacent pair of battery cells.

In certain implementations, the bus bar insulator defines a first welding slot and a second welding slot for welding the bus bar to respective first and second battery cells. The second welding slot is spaced apart from the first welding slot. The bus bar insulator may have a third welding slot associated with the first battery cell and a fourth welding slot associated with the second battery cell. The vehicle traction battery assembly may have a retaining clip within the recess of the bus bar insulator to retain the bus bar within the bus bar insulator. The vehicle traction battery assembly may also have a plurality of retaining tabs integrally formed within the recess of the bus bar insulator.

The present disclosure also relates to a vehicle traction battery assembly having a plurality of battery cells and a plurality of bus bar insulators. The bus bar insulators are each associated with a pair of adjacent battery cells. The bus bar insulators receive an associated bus bar and expose an electrically conductive first surface of the associated bus bar to contact the pair of adjacent battery cells. The bus bar insulators cover a second surface of the associated bus bar that is opposite the first surface. The bus bar insulators define at least one welding slot configured for welding the bus bar to the pair of adjacent battery cells through the at least one welding slot.

The present disclosure further relates to a method for assembling a vehicle traction battery having a plurality of battery cells. The method includes positioning a plurality of bus bars within corresponding recesses of a bus bar insulator and securing the bus bars with integrally formed bus bar retainers within respective recesses. The bus bar insulator substantially covers one side of each bus bar and has a plurality of welding slots with at least one welding slot for each of the plurality of battery cells. The method also includes welding the plurality of bus bars to associated battery cells through the welding slots. The welding slots are preferably sized to prevent human access to the plurality of bus bars without removing the bus bar insulator. The welding slots may be sized based on a published standard for intrusion protection/prevention. The traction battery assembly may include voltage detection or sense leads associated with each pair of cells and having associated wires passing through an integrally formed wiring harness duct. The method may further include inserting the wires into the duct.

Embodiments according to the present disclosure may have various associated advantages. For example, a bus bar cover according to embodiments of the present disclosure allows for assembly of the bus bars to a high voltage array without the need to separate the array into lower voltage groups. A battery assembly process according to various embodiments eliminates a step of closing lids after joining cells together used in previous manufacturing. Use of welded connections according to embodiments of the present disclosure eliminates the more labor intensive fasteners, and eliminates any damage associated with cross-threaded fasteners. The resulting simplified manufacturing and assembly method of various embodiments should provide associated cost reductions.

### BRIEF DESCRIPTION OF THE DRAWINGS

FIG. 1 is a bottom perspective view of a bus bar assembly of the present disclosure showing several connected bus bar insulators with their respective integrated wiring management duct and welding slots that inhibit human access to the bus bar.

FIG. 2 is a bottom perspective view of a bus bar insulator with a bus bar attached to the recess of the bus bar insulator and retained by several retaining clips and tabs.

FIG. 3 is a perspective view of a battery pack that includes the bus bar assembly of FIG. 1.

FIG. 4 is a schematic view of a vehicle having a traction battery with battery cells connected by the bus bar assembly of the present disclosure.

FIG. 5 is a flowchart of a method for connecting battery cells in a battery pack.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

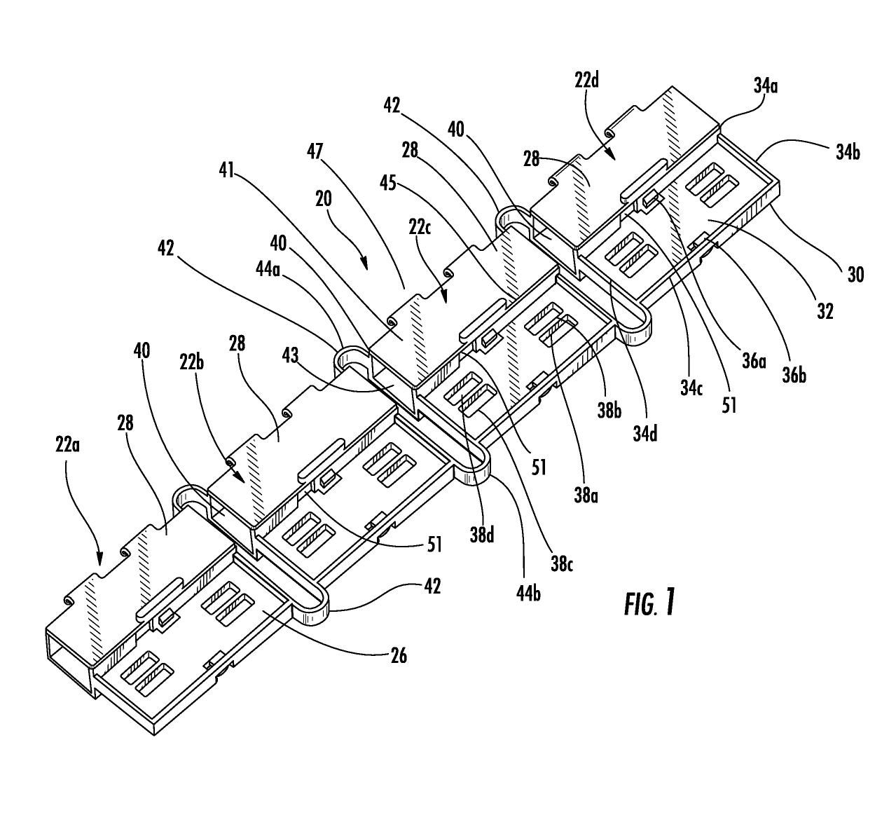

The present disclosure pertains to devices and methods for connecting battery cells, such as the battery cells of fraction batteries used to power hybrid or electric vehicles. Referring to FIG. 1, integrally formed interconnected bus bar insulators 22a-22d for a vehicle fraction battery assembly are shown. The number of bus bar insulators may depend on the number of battery cells to be connected. More than one bus bar assembly may be used for each traction battery depending on the particular application and implementation. In the representative embodiment illustrated, one bus bar insulator 22a, 22b, 22c, or 22d is provided for every pair of battery cells to be connected. Other embodiments may include a bus bar insulator for three or more battery cells, or multiple pairs of battery cells. As illustrated in FIG. 1, the four (4) bus bar insulators 22a-22d in FIG. 1 may be used to connect an array of eight (8) battery cells.

Each insulator 22a, 22b, 22c, 22d includes an integrally formed and integrated wire harness duct 28. The bus bar insulator 22 and the wire harness duct 28 may be made of plastic or other non-conductive or insulating material using a single mold. Bus bar insulator 22 may include a first surface 30 and a second surface 32, which is opposite the first surface 30. The first surface 30 is flat and covers a bus bar except for the bus bar portion to be welded to a battery terminal as further described below. The second surface 32 is also flat and is surrounded by retaining walls 34a-d that create a recess configured to receive and hold the bus bar. The retaining walls 34a-d hold the bus bar within them and substantially prevent the bus bar from moving side-to-side or forward and backward. A pair of retaining clips 36a-b may further be included to secure the bus bar within the retaining walls and against the second surface 32. Retaining clip 36a may be integrally formed or otherwise attached to wall 34a and retaining clip 36b may be attached to wall 34c. The bus bar is positioned within the retaining walls 34a-d prior to welding the bus bar to associated battery cells, and the retaining clips 36a-b hold the bus bar against the second surface 32 as the bus bar assembly is positioned over the battery cells prior to welding.

Bus bar insulators 22a-d are configured to be positioned on a battery cell array such that the second surfaces 32 face the battery terminals of the array, and their associated bus bars come in contact with the battery terminals. Each bus bar insulator 22a, 22b, 22c, or 22d defines at least one welding slot 38a-d. In the representative embodiment illustrated, a plurality of welding slots 38a-d extend through the first surface 30 and the second surface 32. The bus bar insulator 22 includes two welding slots- 38a and 38b associated with a terminal of a first battery cell and two welding slots 38c and 38d associated with a terminal of a second battery cell.

The welding slots, as represented by welding slots 38a-d, are sized to inhibit human contact with the bus bar through the welding slots while permitting a welding beam to weld the bus bar to at least two adjacent battery cells through the welding slots. The size of the welding slots may be based on a published ingress protection standard or rating, such as IEC60529, and measured or tested using a corresponding probe. In one embodiment, a laser welding beam extends through the welding slots to weld the bus bars to associated terminals of the battery cells as described in greater detail below.

Each insulator 22a-d may further include a wiring harness or cable management duct 28 integrally formed and attached to one end of the bus bar insulator 22. The wire harness duct 28 is preferably formed as channel 40 by interconnected walls, such as a top wall 41, a bottom wall 43 opposite the top wall, and two opposing side walls 45 and 47. Wall 45 may be the same wall as retaining wall 34a. Wall 45 defines an opening 51 for accommodating a wire associated with the adjacent pair of connected battery cells. The wire harness ducts 28 of the insulators 22a-d are preferably aligned so that the channels form a substantially straight line. Ducts 28 may include gaps corresponding to the space between insulators 22. The insulators 22a-d may be joined together by integrally formed connectors 42, which may include U-shaped members 44a and 44b, positioned in between the insulators 22a-d. Connectors 42 may be flexible to provide greater tolerance in aligning the bus bar insulator assembly with corresponding battery cell pairs during assembly. The insulators 22a-d may be spaced apart by a predetermined distance that considers the distance between the battery cells in the array, the size of the bus bars, and the size of the bus bar insulators so that the welding slots, the bus bars, and the battery terminals are properly aligned when assembling the battery pack.

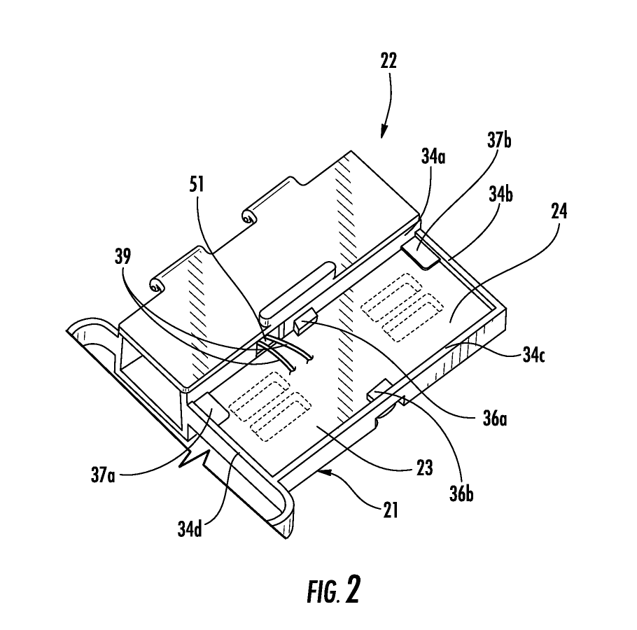

Referring to FIG. 2, a bus bar 24 is positioned within the recess 21 formed by the plurality of retaining walls 34a-d of the bus bar insulator 22. The bus bar 24 has an electrically conductive first surface 23 for contacting adjacent battery cells. The adjacent battery cells may have one or more electrical wires 39 that may be inserted through an opening 51 defined by a wall 45 of the wire harness duct 28 or by retaining wall 34a. The electrical wire 39 is positioned within the wire harness duct 28 that may lead to a battery control module, for example. A plurality of retaining tabs 37a and 37b may also be integrally formed within the recess of the bus bar insulator 22. The retaining tabs 37a and 37b may be positioned at each corner of the recess to further hold the bus bar 24 against the second surface 32 of the bus bar insulator 22. The retaining clips 36a and 36b and the retaining tabs 37a and 37b cooperate to hold the bus bar 24 in place within the recess so that the assembly can be positioned over associated battery cell terminals prior to welding.

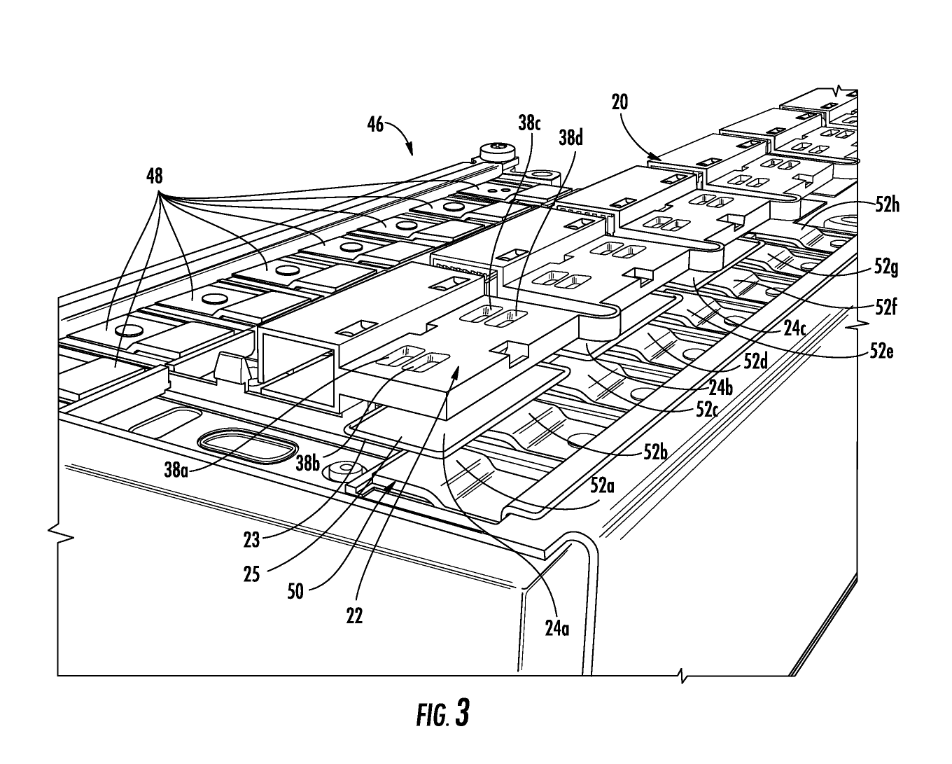

FIG. 3 is a partial perspective view of a representative vehicle fraction battery having a bus bar insulator according to one embodiment of the present disclosure. The exploded or assembly view of FIG. 3 is provided to illustrate the relative positioning of the bus bars relative to the insulator assembly and battery terminal. As previously described, and described in greater detail below, the bus bars may be inserted into the recesses on the underside of the insulator and retained by corresponding tabs or retainers prior to positioning the assembly over associated cells of the battery.

As shown in FIG. 3, the bus bars 24a-c have an electrically conductive second surface 25 that is opposite the first surface 23. The second surface 25 is covered by the bus bar insulator 22, except for the areas where the welding slots 38a-d are defined. Each bus bar insulator 22a-d may include two welding slots associated with each battery cell terminal, such as slots 38a-b associated with terminal 52a of a first battery cell and slots 38c-d associated with terminal 52b of a second battery cell. Bus bars 24a-d that are positioned within associated bus bar insulators 22a-d may be attached to their respective battery terminals 52 by laser welding through the welding slots 38a-d. The welding slots 38a-d are shown to be spaced apart to prevent human contact with the bus bars 24a-d while at the same time providing large enough welding slots to keep the plastic insulator away from the high temperature areas created by the laser weld process. A battery pack 46 is also shown with one array made up of eight battery cells 48. Each cell 48 includes a battery terminal on both ends. The battery terminals of the cells in the array line up in a single line allowing the bus bars of the battery bus bar assembly to be aligned with the line of battery terminals. For instance, on side 50, a vehicle traction battery assembly 20 is shown to be positioned on the array such that bus bar 24a connects terminals 52a and 52b; bus bar 24b connects terminals 52c and 52d; bus bar 24c connects terminals 52e and 52f; and bus bar 24d connects terminals 52g and 52h.

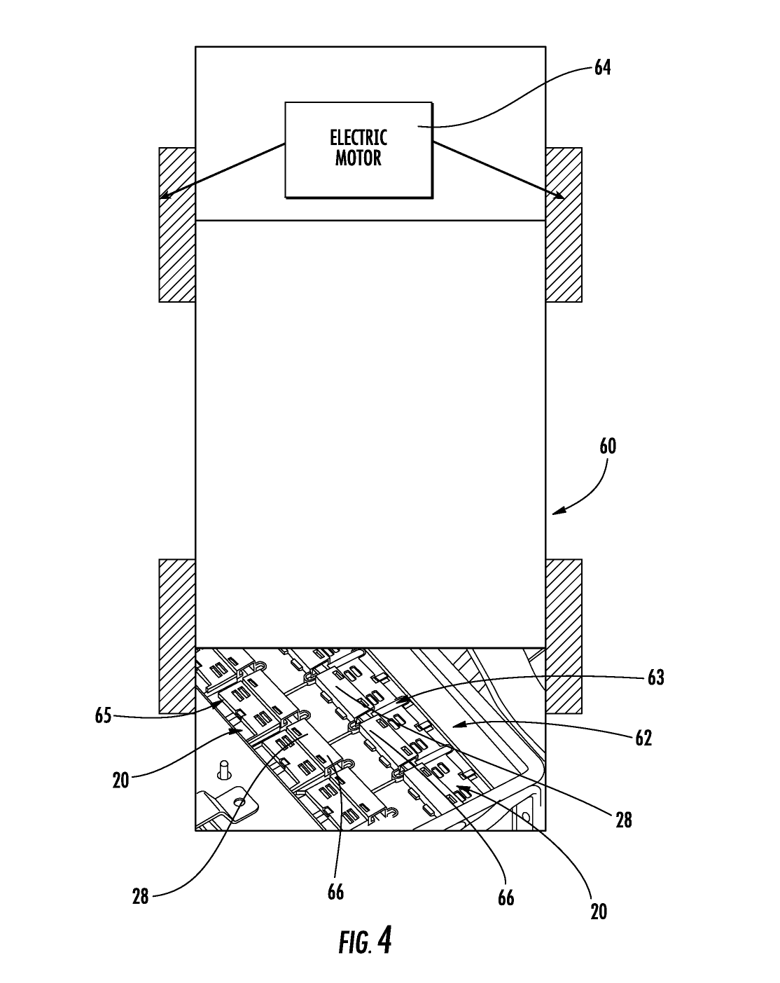

Referring to FIG. 4, a vehicle 60 that uses a battery pack 62 to power its electric motor 64 is shown. Vehicle 60 generally represents an electric or hybrid electric vehicle, which may also include an internal combustion engine. The battery pack 62 may include an array of battery cells connected by the bus bar assemblies 20. The array of the battery pack 62 may have two opposing terminal sides 63 and 65 that are interconnected and covered by the two bus bar assemblies 20 positioned on each terminal side. Of course, the number of the battery arrays and the number of the bus bar assemblies for use with the vehicle may vary. Wires associated with cell voltage sense leads or other wires or cables, generally represented by reference numeral 66, may be positioned within wire harness duct 28 of each of the bus bar insulators. It can be appreciated that the wire harness ducts 28 provide an organized wire management system for a battery pack.

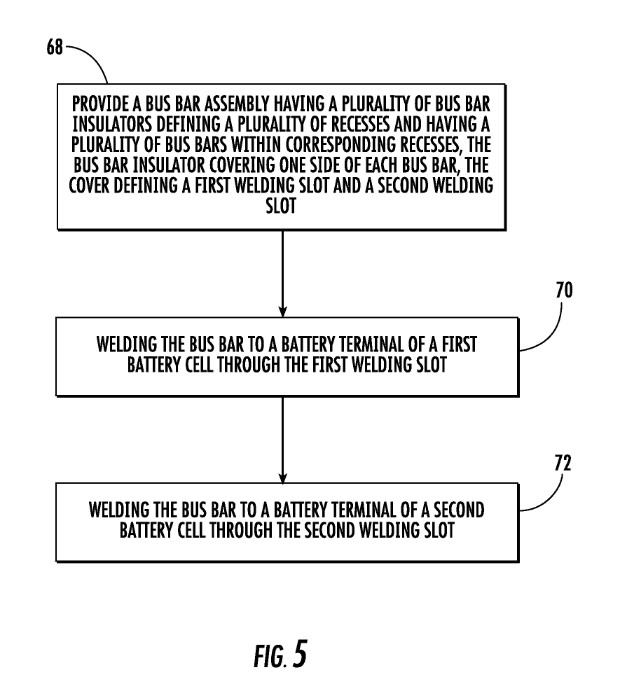

FIG. 5 is a flow chart illustrating a method for assembling a vehicle traction battery having a plurality of battery cells and a bus bar insulator assembly according to embodiments of the present disclosure. Those of ordinary skill in the art will recognize that the steps or functions illustrated may be performed in a different order and/or simultaneously consistent with the teachings of the present disclosure. Similarly, one or more steps may be omitted depending on the particular application and implementation.

As illustrated in FIG. 5, a method of assembling a vehicle traction battery having a plurality of cells may include a bus bar assembly according to various embodiments of the present disclosure. The method may include positioning bus bars in corresponding recesses of a bus bar insulator assembly as generally represented at 68. Each bus bar insulator substantially covers or shields one side of each bus bar. Each bus bar insulator defines first and second welding slots that are spaced apart. The method may include positioning and aligning the bus bar insulator assembly over associated battery cell terminals.

At step 70, one of the bus bars is welded to a battery terminal of a first battery cell through the first welding slot. At step 72, the bus bar is welded to a battery terminal of a second battery cell through the second welding slot. The welding slots are sized to inhibit human access to the electrically conductive bus bars through the bus bar insulator. The method may also include positioning one or more wires extending from the battery terminals of associated battery cells within an integrally formed wire harness duct of the insulator. The bus bar assembly has wire harnesses integrally formed with the bus bar insulators. The wires of the battery cells may be inserted through the wire harness.

As demonstrated by the representative embodiments described above, certain embodiments of the devices and methods for connecting battery cells of the present disclosure provide covers for bus bars that are designed to inhibit human contact with high voltage bus bars while also providing welding slots for connecting the bus bars to the battery terminals. Various embodiments eliminate the use of fasteners for fastening the bus bars to battery terminals and the potential for cross-threading and related repairs. Thus, the devices and methods of the present disclosure may cut down some of the manufacturing steps and costs involved in assembling battery packs. Certain embodiments of the present disclosure may further take away the need for creating 50-volt safety breaks from battery packs and the use of detachable lids to cover the bus bars after connecting them to the battery terminals. Thus, certain embodiments of the present disclosure may reduce the number parts used in manufacturing and simplify the battery pack manufacturing process.

While one or more embodiments have been illustrated and described, it is not intended that these embodiments illustrate and describe all possible embodiments within the scope of the claims. Rather, the words used in the specification are words of description rather than limitation, and various changes may be made without departing from the spirit and scope of the disclosure. While various embodiments may have been described as providing advantages or being preferred over other embodiments or prior art implementations with respect to one or more desired characteristics, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A vehicle traction battery assembly, comprising:
a bus bar insulator having a first side with a recess configured to receive a bus bar and an opposite side covering the bus bar and defining at least one welding slot sized to permit a welding beam to weld the bus bar to at least two adjacent battery cells and to inhibit human contact with the bus bar through the at least one welding slot.

2. The vehicle traction battery assembly of claim 1 further comprising a wire harness duct integrally formed with the bus bar insulator, the wire harness duct including a plurality of walls that define a channel configured to receive a plurality of wires.

3. The vehicle traction battery assembly of claim 2 wherein the wire harness duct includes an opening associated with an adjacent pair of battery cells.

4. The vehicle traction battery assembly of claim 1 wherein the bus bar insulator defines a first welding slot and a second welding slot for welding the bus bar to respective first and second battery cells, the second welding slot being spaced apart from the first welding slot.

5. The vehicle traction battery assembly of claim 4 further comprising a third welding slot associated with the first battery cell and a fourth welding slot associated with the second battery cell.

6. The vehicle traction battery assembly of claim 1 further comprising a retaining clip within the recess of the bus bar insulator configured to retain the bus bar within the bus bar insulator.

7. The vehicle traction battery assembly of claim 1 further comprising a plurality of retaining tabs integrally formed within the recess of the bus bar insulator.

8. The vehicle traction battery assembly of claim 1 further comprising a second bus bar insulator attached to the bus bar insulator, the second bus bar insulator having an integrated wire harness duct that aligns with the wire harness of the bus bar insulator.

9. A vehicle traction battery assembly, comprising:
a plurality of battery cells; and
a plurality of bus bar insulators each associated with a pair of adjacent battery cells and configured to receive an associated bus bar, each insulator configured to expose an electrically conductive first surface of the associated bus bar for contacting the pair of adjacent battery cells and substantially covering a second surface opposite the first surface, each insulator defining at least one welding slot configured for welding the bus bar to the pair of adjacent battery cells through the welding slot.

10. The vehicle traction battery assembly of claim 9 further comprising a wire harness duct integrally formed with the bus bar insulator, the wire harness duct comprising a plurality of walls forming a channel.

11. The vehicle traction battery assembly of claim 9 further comprising a bus bar retaining clip integrally formed with the bus bar insulator and configured to secure the bus bar within the bus bar insulator prior to welding.

12. A method for assembling a vehicle traction battery having a plurality of battery cells comprising:
positioning a plurality of bus bars within corresponding openings of a bus bar insulator, each opening having integrally formed bus bar retainers, the bus bar insulator substantially covering one side of each bus bar and having a plurality of welding slots with at least one welding slot for each of the plurality of battery cells; and
welding the plurality of bus bars to associated battery cells through the welding slots.

13. The method of claim 12 wherein each of the plurality of welding slots is sized to inhibit human access to the plurality of bus bars without removing the bus bar insulator.

14. The method of claim 12 wherein the battery cells include battery wires and the bus bar insulator includes an integrally formed wire harness duct, the method further comprising inserting the battery wires into the wire harness duct.

15. The method of claim 12 wherein the bus bar insulator includes two welding slots associated with each of the plurality of battery cells.
